(19) United States
(12) Patent Application Publication
(10) Pub. No.: US 2008/0107249 A1
(43) Pub. Date: May 8, 2008

(54) Apparatus and method of controlling T-communication convergence service in wired-wireless convergence network

(75) Inventors: Eung Ha Kim, Daejeon-city (KR); Kee Seong Cho, Daejeon-city (KR); Byung Sun Lee, Daejeon-city (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Electronics and Telecommunications Research Institute

(21) Appl. No.: 11/977,662

(22) Filed: Oct. 25, 2007

(30) Foreign Application Priority Data
Nov. 8, 2006 (KR) 10-2006-0110172
Feb. 27, 2007 (KR) 10-2007-0019901

(51) Int. Cl. H04M 11/00

(52) U.S. Cl. 379/93.03; 379/93.05

(57) ABSTRACT

The present invention provides a method and apparatus for controlling a T-communication convergence service in a wired-wireless convergence network, and more particularly, a method and apparatus for providing a function of controlling the T-communication convergence service, in which a communication service and a broadcasting service are converged, without depending on a wired or wireless terminal in a wired-wireless convergence network. According to the method, an IP multimedia subsystem (IMS) based call session control unit and a broadcasting control function are utilized to the utmost so that the T-communication convergence service is used regardless of types of networks and terminals that a user is connected to, and sessions related to performance of the T-communication convergence service and the states of the sessions can be controlled. Also, an environment for providing a policy, which can authenticate a user using the T-communication convergence service and process convergence service in the T-communication convergence service, can be constructed. In addition, by building a system for controlling the T-communication convergence service which can be easily applied to communication networks other than a certain communication network, reusability and portability of the system are increased.

### CROSS-REFERENCE TO RELATED PATENT APPLICATION

This application claims the benefit of Korean Patent Application No. 10-2006-0110172, filed on Nov. 8, 2006 and Korean Patent Application No. 10-2007-0019901, filed on Feb. 27, 2007 in the Korean Intellectual Property Office, the disclosures of which are incorporated herein in their entirety by reference.

### BACKGROUND OF THE INVENTION

1. Field of the Invention

The present invention relates to an apparatus and method of controlling a T-communication convergence service in a wired-wireless convergence network, and more particularly, to an apparatus and method of providing a function of controlling a T-communication convergence service, in which a communication service and broadcasting service are converged, without depending on a wired or wireless terminal in a wired-wireless convergence network. This work was supported by the IT R&D program of MIC/IITA.[2006-S058-01, Development of Network/Service Control Technology in AII-IP based Converged network]

2. Description of the Related Art

T-communication is a convergence service of telecommunication and broadcasting that compounds phone services (VoIP, video phone, multiple video conference, etc.) and internet-based communication services (Instant Messaging, Short-Messaging Service, Email, Web, etc.) with classical television services. In a conventional communication network, services are developed and provided separately, and a communication service and broadcasting service are each provided to a user who requested a service, using a web based service broker using a media gateway, or the like. According to a structure of such a system for controlling services, content suitable for a network environment is separately developed, stored, and served by communication enterprises. Consequently, the content is repeatedly developed, and thus not only is development of the content overly expensive, but also various services cannot be created. In addition, users depend on a network or a wired-wireless terminal to be provided with service.

Fields of communication service and broadcasting service, which have been developed separately, are speedily converging due to enterprisers' desire to create a new business model and user's desire to be provided with various services, in which communication and broadcasting are converged. In order to converge the communication service and broadcasting service, a service system control structure, in which the broadcasting service, such as cable television (CATV) broadcasting, satellite broadcasting, multi-channel internet broadcasting, and video-on-demand (VOD) broadcasting, and an internet service can be simultaneously used with only one wire by using a communication broadcasting convergence access system, is provided. However, in such a service system control structure, the broadcasting service is provided through a TV terminal and the internet service is provided through a personal computer. Accordingly, the service system control structure only transmits broadcasting data and internet data through a wire line, and cannot substantially control a service, in which the communication service and the broadcasting service are converged.

Currently, a broadband convergence network, which provides an environment for using a communication service, broadcasting service, and communication-broadcasting convergence service at anytime, anywhere, without disconnection, is being constructed as a wired-wireless convergence network. However, most of services provided are voice, data, and convergence of voice and data. As a broadcasting service, only an internet based VOD and an internet TV are provided, and a method of controlling the communication and broadcasting converged service is not provided.

According to a conventional service control system, a communication service and broadcasting service are separately provided to a user who requested a service, using a service broker operating based on a web using a media gateway, or the like. Such a method cannot provide a convergence service, and thus it is difficult to create various convergence services and to provide the same service to users regardless of a connected network or terminal. Also, a user interface provides different methods in each terminal.

Also, a service system control structure, in which the broadcasting service, such as CATV broadcasting, satellite broadcasting, multi-channel internet broadcasting, and VOD broadcasting, and an internet service can be simultaneously used with only one wire by using a communication broadcasting convergence access system, is provided. However, the service system control structure only transmits broadcasting data and internet data through a wired line, and cannot substantially control a service, in which the communication service and broadcasting service are converged.

Also, in the broadband convergence network, which is a wired-wireless convergence network, that is currently being constructed, most of services provided are voice, data, and convergence of voice and data. As a broadcasting service, only an internet based VOD and an internet TV are provided, and a method of controlling the communication and broadcasting converged service is not provided.

### SUMMARY OF THE INVENTION

The present invention provides an apparatus and method of controlling a T-communication convergence service in a wired-wireless convergence network, which reuses to the maximum an IP multimedia subsystem (IMS) based call session control unit that can be easily applied to the wired-wireless convergence network, and controls a communication-broadcasting convergence service by using an interface with a broadcasting service control unit. Accordingly, the T-communication convergence service, in which a broadcasting service, such as a television service, voice over internet protocol (VoIP) telephone service, and instant message service are converged, can be provided as a type of service in which communication and broadcasting are converted without depending on a wired-wireless terminal, such as a TV, a personal digital assistant (PDA), or a mobile phone, in the wired-wireless convergence network.

According to an aspect of the present invention, there is provided an apparatus for controlling a T-communication convergence service in a wired-wireless convergence network, the apparatus including: a telecommunication service controller which sets a session for providing at least one of a telephone service and a communication service using an IP multimedia subsystem (IMS) based call session control unit in a wired-wireless convergence network; a broadcasting service controller which sets a session for providing a broadcasting service based on a broadcasting service control unit in the wired-wireless convergence network; and a convergence service provider which controls the set session by using an interface with the telecommunication service controller and the broadcasting service controller, manages states of the sessions, and provides at least one of the telephone service, the communication service, and the broadcasting service to a wired-wireless user terminal according to preset policy, about service providing and conversion between provided services, related to a communication-broadcasting convergence service.

According to another aspect of the present invention, there is provided a method of controlling an initialization of providing a T-communication convergence service in a wired-wireless convergence network, the method including: when a communication-broadcasting convergence service request is received from a user terminal of the wired-wireless convergence network, determining whether a user is a rightful user of the communication-broadcasting convergence service by referring to an integration profile, in which user information and a preset policy related to the communication-broadcasting convergence service, is contained; when the user is determined to be a rightful user, determining a service to be provided initially by checking the preset policy related to the communication-broadcasting convergence service of the user from the integration profile; when the determined service is a broadcasting service, setting a session for providing the broadcasting service using a broadcasting service control unit; when the determined service is a telephone service or a communication service, setting a session for providing the telephone service or the communication service using an IMS based call session set function; storing the set session for providing the broadcasting service, telephone service, or communication service in an internal space for the user and changing states of the set session to busy states; and providing content of the service to a user terminal after converting the content based on characteristics of the user terminal and a connected network through the set session.

According to another aspect of the present invention, there is provided a method of controlling conversion of a T-communication convergence service in a wired-wireless convergence network, the method including: when a message reception request, which is communication service, is received by a user terminal while providing a broadcasting service to the user terminal based on a preset policy related to a communication-broadcasting convergence service, confirming that the user terminal is provided with the communication-broadcasting convergence service from an integration profile, in which user information and communication-broadcasting convergence service utilization state information of a user are stored; setting a communication message session for receiving a requested message by using an IMS based call session control function; storing the set communication message session in an internal space and changing state of the set communication message session to a busy state; and providing the requested message to the user terminal through the set communication message session by using the call session control function.

According to another aspect of the present invention, there is provided a method of controlling conversion of a T-communication convergence service in a wired-wireless convergence network, the method including: when a request for providing a VoIP service is received by a user terminal while providing a broadcasting service to the user terminal based on a preset policy related to a communication-broadcasting convergence service, confirming that the user terminal is provided with the communication-broadcasting convergence service from an integration profile, in which user information and communication-broadcasting convergence service utilization state information of a user are stored; pausing transmitting of a broadcasting service stream to the user terminal by recognizing that the broadcasting service is being provided from among the communication-broadcasting convergence service; storing the broadcasting service stream, which is transmitted from a server, for a pausing period, and changing a state of a session for the broadcasting service to a pause state; setting a session for the requested VoIP service using an IMS based call session control function; storing the set session for the requested VoIP service and changing a state of the set session for the requested VoIP service to a busy state; and connecting the requested VoIP service to the user terminal through the set session for the requested VoIP service by using the call session control function.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an apparatus for controlling a T-communication convergence service, which is a communication-broadcasting convergence service in a wired-wireless convergence network environment according to an embodiment of the present invention;

FIG. 2 is a diagram illustrating a system for controlling a T-communication convergence service in a wired-wireless convergence network environment according to an embodiment of the present invention;

FIG. 3 is a diagram illustrating a scenario for providing a T-communication convergence service in a wired-wireless convergence network environment according to an embodiment of the present invention;

FIG. 4 is a flowchart illustrating a method of controlling an initialization of providing a T-communication convergence service, which is a communication-broadcasting convergence service, according to an embodiment of the present invention;

FIG. 5 is a flowchart illustrating a method of controlling conversion of a T-communication convergence service related to processing of a message reception request while providing a broadcasting service according to an embodiment of the present invention;

FIG. 6 is a flowchart illustrating a method of controlling conversion of a T-communication convergence service related to processing of a voice over internet protocol (VoIP) service request while providing a broadcasting service according to an embodiment of the present invention; and

FIGS. 7A through 7H are flowcharts illustrating a method of controlling conversion of a T-communication convergence service, which is a communication-broadcasting convergence service in a wired-wireless convergence network environment according to an embodiment of the present invention.

### DETAILED DESCRIPTION OF THE INVENTION

Hereinafter, the present invention will be described more fully with reference to the accompanying drawings, in which exemplary embodiments of the invention are shown.

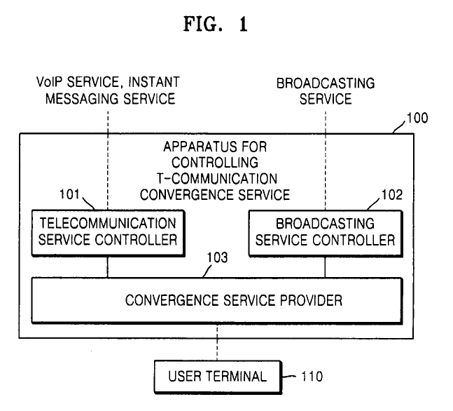

FIG. 1 is a diagram illustrating an apparatus 100 for controlling a T-communication convergence service, which is a communication-broadcasting convergence service in a wired-wireless convergence network environment according to an embodiment of the present invention.

Communication broadcasting convergence is a phenomenon in which boundaries of enterprise classification and regulation become ambiguous by simultaneously providing a broadcasting service and a communication service through a broadband single network, and is defined by several organizations.

The current embodiment of the present invention is about the apparatus 100 for controlling the T-communication convergence service, which is such a communication broadcasting convergence in a wired-wireless convergence network. Using the apparatus 100, controlling of the T-communication convergence service is managed, setting of a session related to telephone service or communication service is performed by using an interface with a call session control unit according to a policy about the T-communication convergence service stored in an integration profile, setting of a session related to broadcasting service is performed by using an interface with a broadcasting service control unit, and a function of controlling the T-communication convergence service is performed by managing the set sessions and the states of the sessions.

Referring to FIG. 1, the apparatus 100 includes a telecommunication service controller 101, which sets a session for providing a telephone service or a communication service using an IP multimedia subsystem (IMS) based call session control function in a wired-wireless convergence network, a broadcasting service controller 102, which sets a session for providing a broadcasting service based on a broadcasting service control function in the wired-wireless convergence network, and a convergence service provider 103, which controls the set sessions by using an interface with the telecommunication service controller 101 and the broadcasting service controller 102, manages states of the sessions, and provides at least one of the telephone service, the communication service, and the broadcasting service to a wired/wireless user terminal 110 according to preset policy information, about service providing and conversion between provided services, related to the communication-broadcasting convergence service.

The telephone service includes a voice over IP (VoIP) service besides conventional wired/wireless telephone network services, and the communication service includes an internet based instant messaging service. Also, the broadcasting service includes general broadcasting services, such as a cable television (CATV) broadcasting service, satellite broadcasting service, multi-channel internet broadcasting service, and video-on-demand (VOD) broadcasting service. The wired-wireless convergence network includes a broadband convergence network (BcN).

Considering detailed components, the apparatus 100 further includes a service broker unit (not shown), which controls application servers required for providing the communication-broadcasting convergence service based on a preset policy related to the communication-broadcasting convergence service, an integration profile storage unit (not shown), which contains at least one of user information, information about a usable communication-broadcasting convergence service list, and preset policy information related to the communication-broadcasting convergence service, and a convergence service manager (not shown), which provides the policy information stored in the integration profile storage unit to the convergence service provider 103 and authenticates a user who requested the communication-broadcasting convergence service.

Also, the apparatus 100 further includes a service directory (not shown), which contains information about a service list that can be provided to a user, and a user interface unit (not shown), which provides a service list that can be selected by a certain user from the service directory, and based on the type of service selected by the user, transmits a service process request to the convergence service provider 103 when the communication-broadcasting convergence service is selected, to the telecommunication service controller 101 when the telephone service or the communications service is selected, and to the broadcasting service controller 102 when the broadcasting service is selected.

The telecommunication service controller 101 performs a network connection control function and resource control function for wired-wireless convergence control, and when the user terminal 110 is connected to a network, determines whether the user terminal 110 is a usable terminal based on the information of the integration profile storage unit. The convergence service provider 103 provides content of the communication-broadcasting convergence service to the user terminal 110 after transcoding the content based on characteristics of the user terminal 110 and the connected network. Also, the broadcasting service controller 102 performs a streaming control function required for providing the broadcasting service.

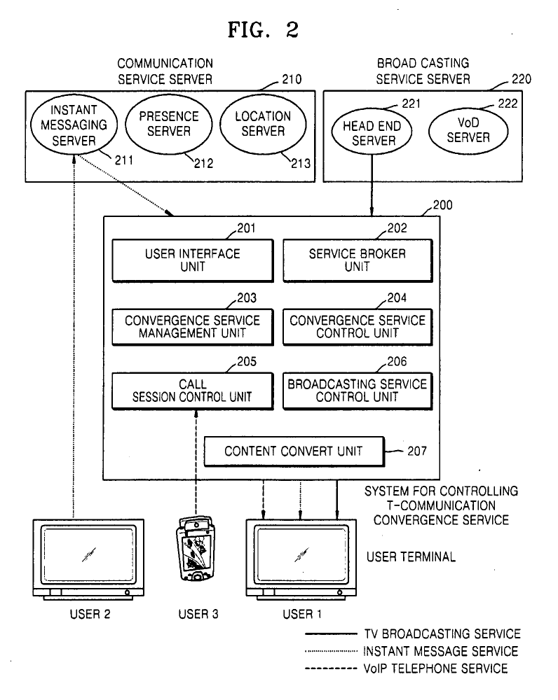

FIG. 2 is a diagram illustrating a system 200 for controlling a T-communication convergence service in a wired-wireless convergence network environment according to an embodiment of the present invention.

In a method of controlling a communication-broadcasting convergence service according to an embodiment of the present invention, controlling of the T-communication convergence service is managed, setting of a session related to a telephone service or a communication service is performed by using an interface with a call session control unit 205 according to a policy about the T-communication convergence service stored in an integration profile, setting of a session related to the broadcasting service is performed by using an interface with a broadcasting service control unit 206, which performs a control function for providing general broadcasting services, such as a CATV broadcasting service, satellite broadcasting service, and VOD broadcasting service, and a function of controlling the T-communication convergence service is performed by managing the set sessions and the state of the session.

Preferably, the method provides the policy to the convergence service control unit 204 by accessing the integration profile, and authenticates a user, who requested the convergence service, in terms of whether the convergence service can be provided to the user.

Preferably, a method of controlling a user interface is provided, in which a selectable service list is outputted to a user terminal, and according to the type of service selected by a user, the convergence service control unit 204 is requested to process a corresponding service when the selected service is the convergence service, the to the call session control unit 205 is requested to process a corresponding service when the selected service is telephone service or communication service, and the broadcasting service control unit 206 is requested to process a corresponding service when the selected service is broadcasting service.

Preferably, a method of controlling a wired-wireless call session is provided, which performs a session connection function according to a request to set the session for the telephone service or communication service of the convergence service control unit 204 in order to control the T-communication convergence service.

Preferably, a method of controlling the broadcasting service is provided, which performs a session connection function for the broadcasting service according to a request to set the session for the broadcasting service of the convergence service control unit 204 in order to control the T-communication convergence service.

Preferably, a method of converting content is provided, which transcodes content of the T-communication convergence service in real time according to characteristics of a terminal or a connected network.

Referring to FIG. 2, the system 200 includes a service broker unit 202, the convergence service control unit 204, a convergence service management unit 203, an integration profile (not shown), the call session control unit 205, the broadcasting service control unit 206, a content convert unit 207, a user interface unit 201, and a service directory (not shown).

The service broker unit 202 selects and controls an application server required in performing a service selected by a user. When the user selects a T-communication convergence service, the service broker unit 202 controls application servers required in performing the T-communication convergence service by receiving policy information about the T-communication convergence service from the convergence service control unit 204.

The convergence service control unit 204 controls the whole system 200, and in order to perform the T-communication convergence service, formed of a telephone service, instant message service, and broadcasting service, according to a policy defined in a convergence service profile, controls related sessions and manages states of the related sessions by mutually connecting with the call session control unit 205 and the broadcasting service control unit 206.

The convergence service management unit 203 provides a policy required in controlling the convergence service to the convergence service control unit 204 by accessing the integration profile, and authenticates a user who requested the convergence service, in terms of whether the user can use the convergence service. The integration profile is formed of user information, information about a usable convergence service list, and policy information for controlling the convergence service.

The user interface unit 201 outputs a usable service list to the user terminal, and according to the type of service selected by a user, requests the convergence service control unit 204 to process a corresponding service when the selected service is the convergence service, requests the call session control unit 205 when the selected service is the telephone service or communication service, and requests the broadcasting service control unit 206 when the selected service is the broadcasting service. The service directory contains information about a usable service list, such as the telephone service, communication service, and broadcasting service, and also includes the convergence service.

The call session control unit 205 performs a session connection function used in performing an IP multimedia subsystem (IMS) based communication service, and a network connection control function and resource control function for wired-wireless convergence control. Also, when the user connects to a network by using the user terminal, the call session control unit 205 authenticates the user by using the integration profile.

The broadcasting service control unit 206 performs a streaming control function required for providing the broadcasting service. The content convert unit 207 transcodes content of the broadcasting service or telephone service, forming the T-communication convergence service, in real time according to characteristics of the user terminal and a network connected to the user terminal.

A communication service server 210 includes an instant messaging server 211, which is related to transmitting/receiving an instant message, a presence server 212, and a location server 213, and a broadcasting service server 220 includes a head end server 221, and a video on demand (VoD) server 222.

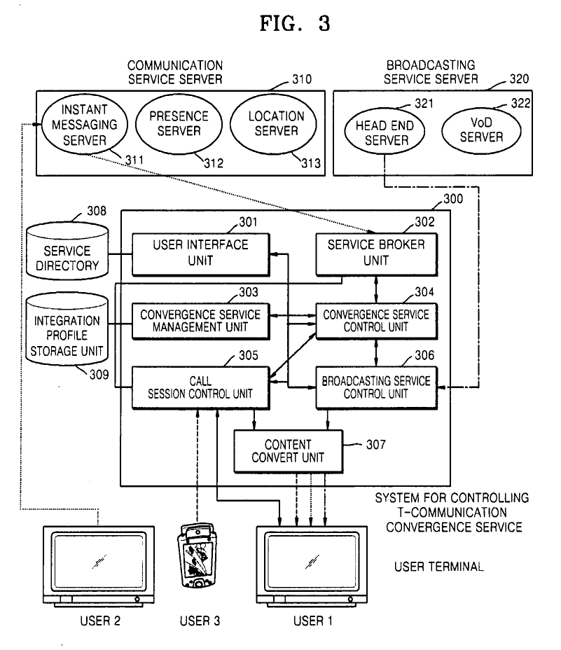

FIG. 3 is a diagram illustrating a scenario for providing T-communication convergence service in a wired-wireless convergence network environment according to an embodiment of the present invention.

According to FIG. 3, a wired terminal, such as a TV which can provide a TV service, a PC, and a wireless terminal, such as a personal digital assistant (PDA) or mobile phone, are used through a system 300 for controlling a T-communication convergence service so that the T-communication convergence service can be used in the wired-wireless convergence network. Accordingly, the T-communication convergence service can be provided to users at anytime and anywhere.

Referring to FIG. 3, when a user 1 turns on a TV terminal, a usable service list is outputted onto a screen of the TV terminal. When the user 1 selects a T-communication convergence service from among the service list, a broadcasting service server 320 transmits a broadcasting stream to the TV terminal, and thus the user 1 can watch TV. At this time, a user 2 transmits an instant message to the user 1, and the user 1 receives the instant message while watching TV. Simultaneously, when a user 3 makes an internet phone call to the user 1, the TV service is paused and the user 1 can receive the internet phone call. When the internet phone call ends, the TV service is reproduced again so that the user 1 can watch TV. Accordingly, FIG. 3 conceptually illustrates the scenario of receiving the T-communication convergence service.

Compositions of the system 300 are to the same as those of the system 200 illustrated in FIG. 2.

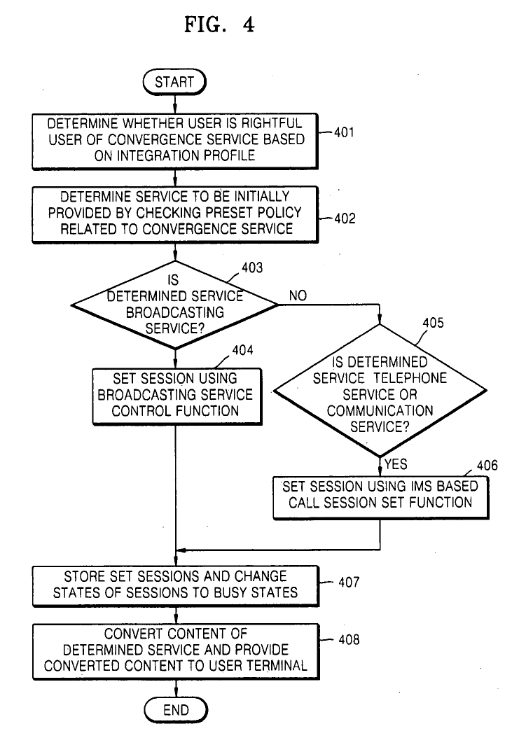

FIG. 4 is a flowchart illustrating a method of controlling an initialization of providing a T-communication convergence service, which is a communication-broadcasting convergence service, according to an embodiment of the present invention.

Referring to FIG. 4, it is determined whether a user is a rightful user of the communication-broadcasting convergence service in operation 401 based on an integration profile, in which user information in a wired-wireless convergence network or a preset policy related to the communication-broadcasting convergence service are stored. When the user is determined to be a rightful user, the service to be initially provided is determined in operation 402 by checking the preset policy in the integration profile.

When the determined service to be initially provided is a broadcasting service in operation 403, a session for providing the broadcasting service is set in operation 404 by using a broadcasting service control function. When the determined service is a telephone service or communication service in operation 405, a session for providing the telephone service or communication service is set in operation 406 using an IMS based call session set function. The set session is stored in an internal space for the user, and the state of the set session is changed to busy states in operation 407.

Content of the determined service is changed based on characteristics of a user terminal and a connected network through the set sessions and then provided to the user terminal in operation 408.

The method includes a process of authenticating the user terminal, which is performed before operation 401, by determining, when a user terminal connected to the wired-wireless convergence network is found, whether the user terminal is a usable terminal using an IMS based call session control function. When the user terminal is authenticated, a service list that can be provided is provided to the user terminal by using a user interface.

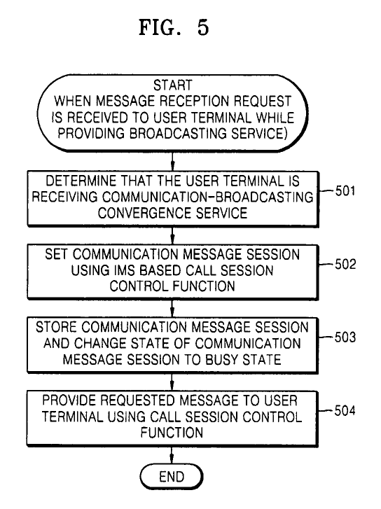

FIG. 5 is a flowchart illustrating a method of controlling conversion of a T-communication convergence service related to processing of a message reception request while providing a broadcasting service according to an embodiment of the present invention.

The method is for converting the T-communication convergence service when the message reception request, which is communication service, is received by a user terminal while providing the broadcasting service to the user terminal based on a preset policy related to a communication-broadcasting convergence service.

Referring to FIG. 5, it is determined that the user terminal is receiving the communication-broadcasting convergence service in operation 501 based on an integration profile, in which user information and communication-broadcasting convergence service utilization state information of a user are stored. Then, a communication message session for receiving a requested message is set in operation 502 using an IMS based call session control function. The communication message session is stored in an internal space, and the state of the communication message session is changed to a busy state in operation 503.

Then, the requested message is provided to the user terminal in operation 504 through the communication message session using the call session control function. Here, the requested message is an internet based instant message.

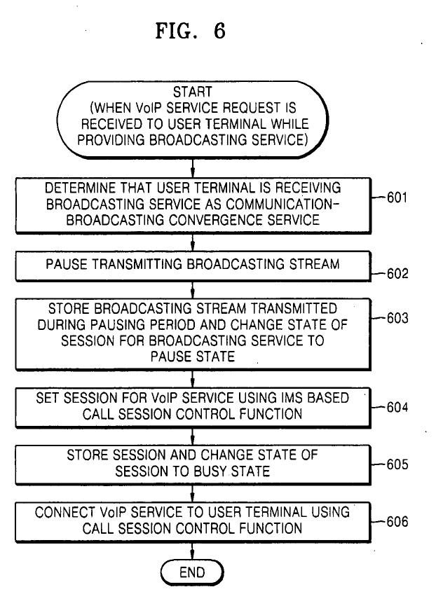

FIG. 6 is a flowchart illustrating a method of controlling conversion of a T-communication convergence service related to processing of a VoIP service request while providing a broadcasting service according to an embodiment of the present invention.

The method is for converting the T-communication convergence service when the VoIP service request is received by a user terminal while providing a broadcasting service to the user terminal based on a preset policy related to a communication-broadcasting convergence service.

Referring to FIG. 6, it is determined that the user terminal is receiving the communication-broadcasting convergence service, specifically the broadcasting service, in operation 601 based on an integration profile, in which user information and communication-broadcasting convergence service utilization state information of a user are stored. Accordingly, a broadcasting stream transmitted to the user terminal is paused in operation 602. Then, the broadcasting stream transmitted during the pausing period is stored in an internal space and the state of a session for the broadcasting service is changed to a pause state in operation 603.

A session for the requested VoIP service is set in operation 604 based on an IMS based call session control function, and the session is stored in an internal space for the user and state of the session is changed to a busy state in operation 605.

Then, the requested VoIP service is connected to the user terminal in operation 606 by using the call session control function.

However, when VoIP communication is completed after the connection in operation 606, the state of the session for the VoIP service stored in the internal space is changed to an unused state, the state of the session for the broadcasting service, which was paused, is changed to a busy state, and the broadcasting stream, which was transmitted and stored in the internal space for the pausing period, is transmitted to the user terminal and then reproduced.

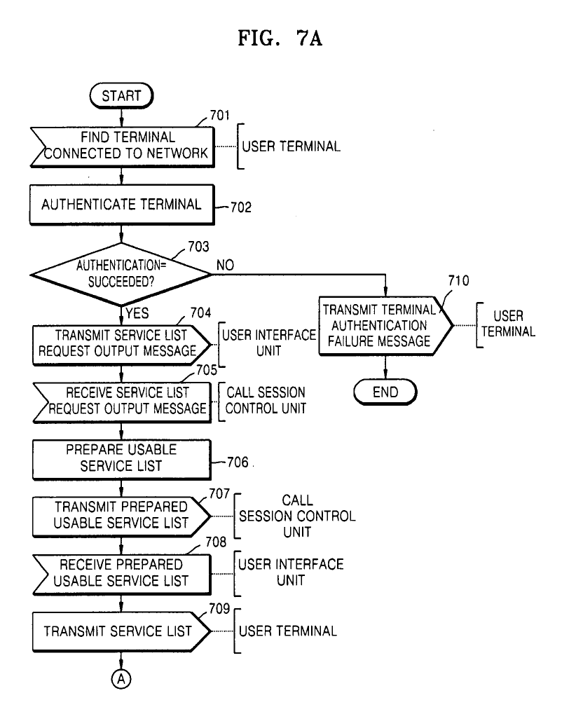

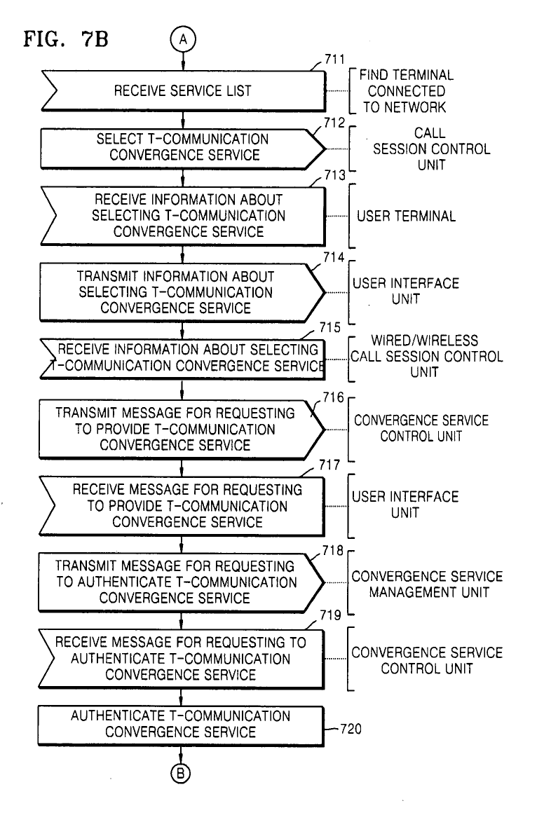

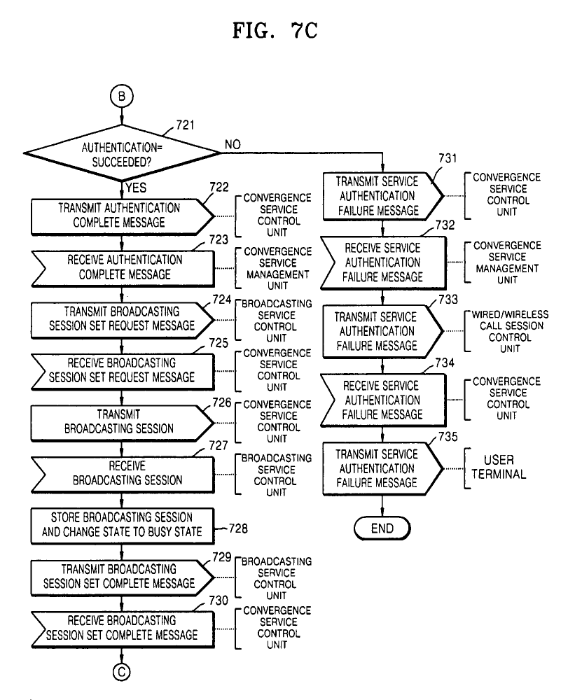

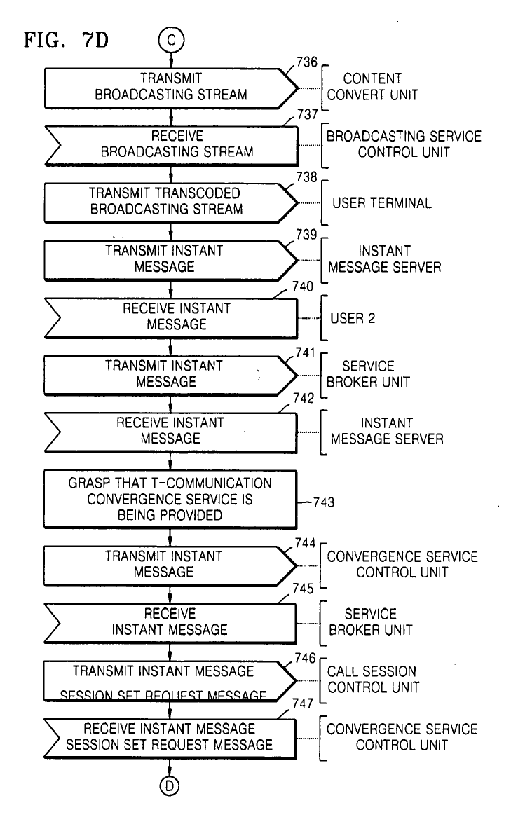

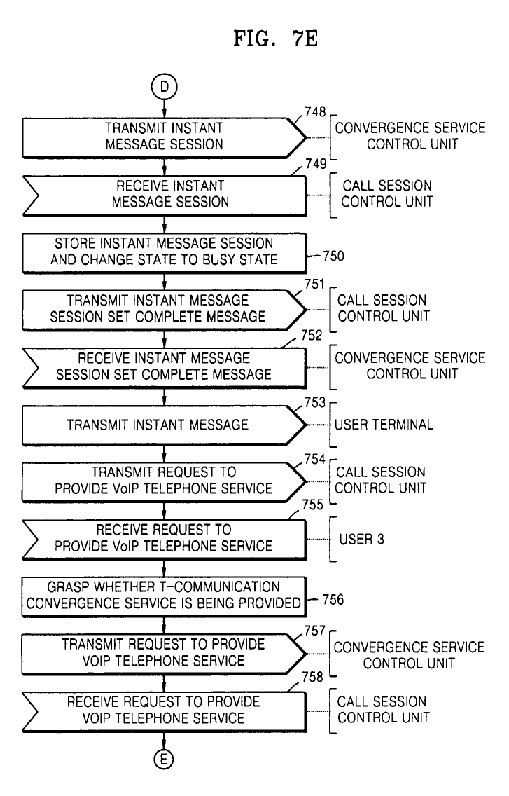

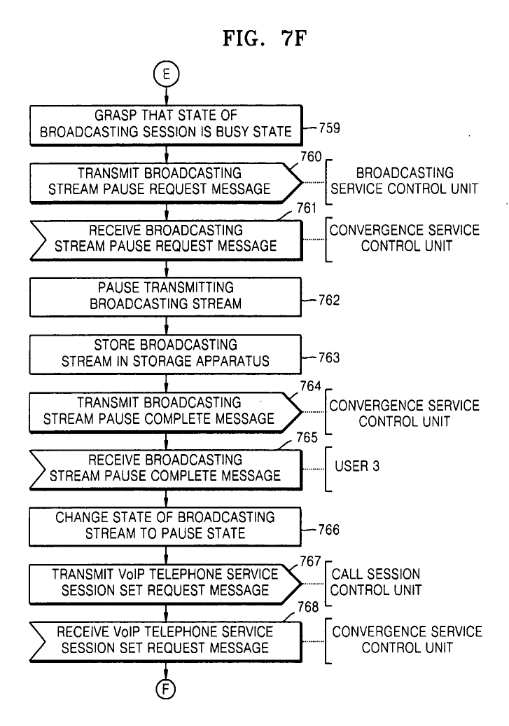

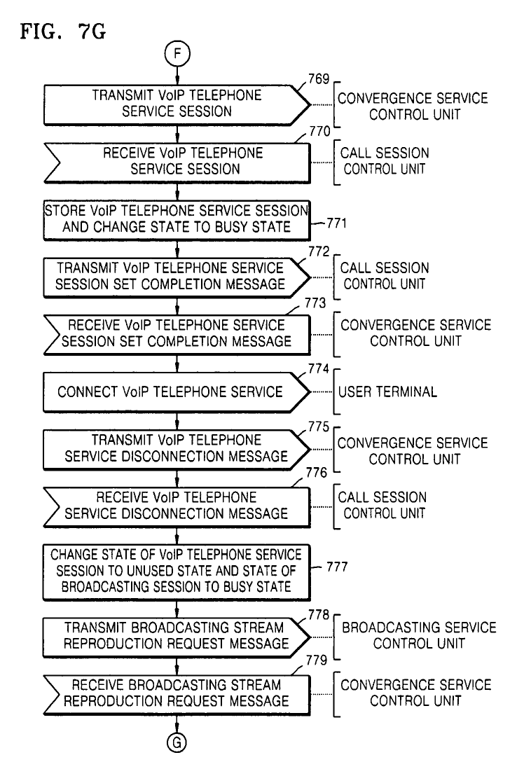

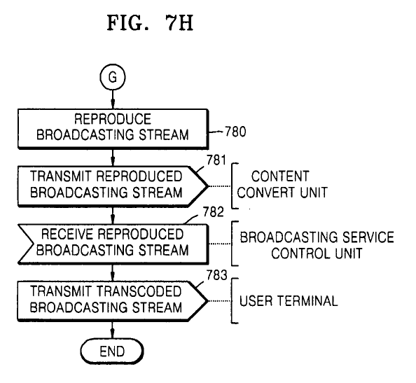

FIGS. 7A through 7H are flowcharts illustrating a method of controlling conversion of a T-communication convergence service, which is a communication-broadcasting convergence service in a wired-wireless convergence network environment according to an embodiment of the present invention.

The flowcharts illustrate a function of controlling the T-communication convergence service, and an overall flow of controlling the T-communication convergence service will now be described with reference to FIGS. 7A through 7H.

First, the function of controlling the T-communication convergence service starts when a user 1 turns on a TV serviceable wired or wireless terminal. When a user terminal is turned on, the corresponding user terminal connected to a network is found in operation 701 using a call session control unit, and authenticates whether the corresponding user terminal is usable in operation 702 by accessing an integration profile.

If it is determined that the authentication failed in operation 703, the call session control unit transmits a terminal authentication failure message to the user terminal in operation 710. If it is determined that the authentication succeeded in operation 703, the call session control unit transmits a service list output request message to a user interface unit which requests the user terminal to output a service list in operation 704. Upon receiving the service list output request message in operation 705, the user interface unit prepares a usable service list in operation 706 by accessing a service directory, and transmits the service list to the call session control unit in operation 707. Upon receiving the service list in operation 708, the call session control unit transmits the service list to the user terminal in operation 709.

The user 1 selects the T-communication convergence service in operation 712 from among the service list outputted to the user terminal, which received the service list in operation 711. The call session control unit receives the T-communication convergence service in operation 713 and transmits information about selecting the T-communication convergence service to the user interface unit in operation 714. Upon receiving the information from the call session control unit in operation 715, the user interface unit transmits a message for requesting to provide the T-communication convergence service to a convergence service control unit in operation 716.

Upon receiving the message for requesting to provide T-communication convergence service in operation 717, the convergence service control unit transmits a message for requesting to authenticate the T-communication convergence service to a convergence service management unit in operation 718 in order to check whether the user 1 can use the T-communication convergence service. Upon receiving the message for requesting to authenticate the T-communication convergence message in operation 719, the convergence service management unit authenticates whether the user 1 can use the T-communication convergence service in operation 720 by accessing the integration profile.

When it is determined that the authentication failed in operation 721, a service authentication failure message is transmitted to the convergence service control unit in operation 731. Upon receiving the service authentication failure message in operation 732, the convergence service control unit transmits the service authentication failure message to the call session control unit in operation 733. Upon receiving the service authentication failure message in operation 734, the call session control unit transmits the service authentication failure message to the user terminal in operation 735.

Meanwhile, when it is determined that the authentication succeeded in operation 721, an authentication complete message is transmitted to the convergence service control unit with policy information, which is information about performing the T-communication convergence service, in operation 722. Upon receiving the authentication complete message in operation 723, the convergence service control unit requests a broadcasting session set request message to a broadcasting service control unit in operation 724 in order to set a broadcasting session so that broadcasting service can be provided to the user terminal according to the policy information.

Upon receiving the broadcasting session set message in operation 725, the broadcasting service control unit sets a broadcasting session, and transmits the set broadcasting session to the convergence service control unit in operation 726. Upon receiving the broadcasting session in operation 727, the convergence service control unit stores the broadcasting session from among sessions for providing the T-communication convergence service of the user 1 in an internal storage space, and turns the state of the broadcasting session to a busy state in operation 728. Then, the convergence service control unit transmits a broadcasting session set complete message to a broadcasting service control unit in operation 729. Accordingly, the broadcasting service control unit receives the broadcasting session set complete message in operation 730.

Upon receiving the broadcasting session set complete message, the broadcasting service control unit transmits a broadcasting stream, provided from a head end server, to a content convert unit in operation 736. Upon receiving the broadcasting stream in operation 737, the content convert unit transcodes the broadcasting stream so as to be suitable for a user terminal codec so that the broadcasting stream can be viewed in the user terminal used by the user 1, and transmits the transcoded broadcasting stream to the user terminal in operation 738. When a user 2 transmits an instant message to the user 1 in operation 739 while the user 1 is receiving the TV service, an instant message server receives the instant message in operation 740, and transmits the instant message to a service broker unit in operation 741.

Upon receiving the instant message in operation 742, the service broker unit grasps that the user 1 is receiving the T-communication convergence service in operation 743 by accessing the integration profile, and transmits the instant message to the convergence service control unit in operation 744.

Upon receiving the instant message in operation 745, the convergence service control unit transmits an instant message session set request message to the call session control unit in operation 746 in order to set a session for the instant message. Accordingly, the call session control unit receives the instant message session set request message in operation 747.

Upon receiving the instant message session set request message, the call session control unit sets the instant message session and transmits the instant message session to the convergence service control unit in operation 748. Upon receiving the instant message session in operation 749, the convergence service control unit stores the instant message session, from among the sessions for providing the T-communication convergence service of the user 1 in the internal storage space, in the integration profile and changes the state of the instant message session to a busy state in operation 750.

Then, the convergence service control unit transmits an instant message session set completion message to the call session control unit in operation 751. Upon receiving the instant message session set complete message in operation 752, the call session control unit transmits the instant message to the user terminal of the user 1 in operation 753. Accordingly, the user 1 can be provided with both the TV service and instant message service. At this time, when a user 3 calls in VoIP to the user 1, a request to provide a VoIP telephone service is transmitted to the call session control unit in operation 754.

Upon receiving the request to provide the telephone service in operation 755, the call session control unit determines whether the T-communication convergence service is provided to the user 1 in operation 756 by accessing the integration profile, and transmits the VoIP telephone service to the convergence service control unit in operation 757.

Upon receiving the VoIP telephone service in operation 758, the convergence service control unit determines that the state of the broadcasting session from among the sessions for the T-communication convergence service of the user 1 is the busy state in operation 759, and transmits a broadcasting stream pause request message, which requests the broadcasting service control unit to pause transmitting of the broadcasting stream in operation 760.

Upon receiving the broadcasting stream pause request message in operation 761, the broadcasting service control unit pauses transmitting the broadcasting stream, which was being transmitted to the user 1, in operation 762, stores the broadcasting stream from the head end server in a storage apparatus in operation 763, and transmits a broadcasting stream pause completion message to the convergence service control unit in operation 764. Upon receiving the broadcasting stream pause completion message in operation 765, the convergence service control unit changes the state of the broadcasting session in the internal storage space to a pause state in operation 766, and transmits a VoIP telephone service session set request message to the call session control unit in operation 767.

Upon receiving the VoIP telephone service session set message in operation 768, the call session control unit sets a VoIP telephone service session and transmits the VoIP telephone service session to the convergence service control unit in operation 769. Upon receiving the VoIP telephone service session in operation 770, the convergence service control unit stores the VoIP telephone service session from among the sessions for providing T-communication convergence service of the user 1 in the internal storage space, and changes the state of the VoIP telephone service session to a busy state in operation 771. Then, a VoIP telephone service session set completion message is transmitted to the call session control unit in operation 772. Upon receiving the VoIP telephone service session set completion message in operation 773, the call session control unit connects a VoIP telephone to the user terminal of the user 1 in operation 774.

When the user 1 disconnects the VoIP telephone, the call session control unit transmits a VoIP telephone service disconnection message to the convergence service control unit in operation 775. Upon receiving the VoIP telephone service disconnection message in operation 776, the convergence service control unit changes the state of the VoIP telephone service session in the internal storage space to an unused state and changes the state of the broadcasting session to a busy state in operation 777, and then transmits a broadcasting stream reproduction request message to the broadcasting service control unit in operation 778.

Upon receiving the broadcasting stream reproduction request message in operation 779, the broadcasting service control unit reproduces the corresponding broadcasting stream, which was paused, from the storage apparatus in operation 780, and transmits the reproduced broadcasting stream to the content convert unit in operation 781. Upon receiving the broadcasting stream in operation 782, the content convert unit transcodes the received broadcasting stream so as to be suitable for a terminal codec so that the broadcasting stream can be viewed in the user terminal of the user 1, and transmits the transcoded broadcasting stream to the user terminal in operation 783.

According to the scenario illustrated in FIG. 3, when the user 1 turns on the user terminal connected to the wired-wireless convergence network, the call session control unit in the system for controlling the T-communication convergence service control system finds the corresponding user terminal and authenticates the corresponding terminal in terms of whether it is a usable terminal by accessing the integration profile. When the authentication succeeds, the user interface unit is requested to output the service list to the user terminal. Upon receiving the request to output the service list, the user interface unit accesses the service directory in order to prepare a usable service list, and transmits the usable service list to the call session control unit. Upon receiving the service list, the call session control unit transmits the service list to the user terminal.

The user 1 selects the T-communication convergence service from among the service list outputted from the user terminal, which received the service list. The call session control unit receives the selected T-communication convergence service and transmits information about selecting the T-communication convergence service to the user interface unit. Upon receiving the information from the call session control unit, the user interface unit requests the convergence service control unit to provide the T-communication convergence service. Then, the convergence service control unit transits a message requesting to authenticate the T-communication convergence service to the convergence service management unit in order to check whether the user 1 can use the T-communication convergence service.

Upon receiving the message, the convergence service management unit authenticates the user 1 in terms of whether the user 1 can use the T-communication convergence service by accessing the integration profile. When the authentication is completed, an authentication complete message is transmitted to the convergence service control unit with policy information, which is information about performing the T-communication convergence service. Upon receiving the authentication completion message, the convergence service control unit transmits a broadcasting session set request message to the broadcasting service control unit in order to set a broadcasting session in such a way that the broadcasting service can be provided to the user terminal according to the policy information.

Upon receiving the broadcasting session set request message, the broadcasting service control unit sets the broadcasting session and transmits the set broadcasting session to the convergence service control unit. Then, the convergence service control unit stores the broadcasting session from among the sessions for providing the T-communication convergence service of the user 1 in the internal storage space, and changes the state of the broadcasting session to a busy state. Next, the convergence service control unit transmits the broadcasting session set completion message to the broadcasting service control unit. Upon receiving the broadcasting session set completion message, the broadcasting service control unit transmits the broadcasting stream provided from the head end server to the content convert unit. Then, the content convert unit transcodes the broadcasting stream so as to be suitable for the terminal codec so that the broadcasting stream can be viewed in the user terminal of the user 1, and transmits the transcoded broadcasting stream to the user terminal.

Accordingly, when the user 2 transmits the instant message to the user 1 while the user 1 is provided with the TV service, the instant message server transmits the instant message of the user 2 to the service broker unit. Upon receiving the instant message, the service broker unit transmits the instant message to the convergence service control unit by accessing the integration profile, since the user 1 is provided with the T-communication convergence service. Then, the convergence service control unit transmits the instant message session set request message to the call session control unit in order to set the session of the instant message.

Upon receiving the instant message session set request message, the call session control unit sets the instant message session and transmits the instant message session to the convergence service control unit. Then, the convergence service control unit stores the instant message session, from among the sessions for providing the T-communication convergence service of the user 1 in the internal storage space, in the integration profile, and changes the state of the instant message session to a busy state.

Next, the instant message session set completion message is transmitted to the call session control unit. Upon receiving the instant message session set completion message, the call session control unit transmits the instant message to the user terminal of the user 1. Accordingly, the user 1 can receive the TV service while receiving the instant message service. At this time, when the user 3 calls the user 1 in VoIP, a request to provide the telephone service is transmitted to the call session control unit. Then, the call session control unit transmits the VoIP telephone service to the convergence service control unit by accessing the integration profile, since the user 1 is receiving the T-communication convergence service.

Upon receiving the VoIP telephone service, the convergence service control unit transmits a broadcasting stream pause request message, which requests to pause transmitting of the broadcasting stream, to the broadcasting service control unit since the state of the broadcasting session is the busy state. Accordingly, the broadcasting service control unit pauses transmitting the broadcasting stream to the user 1, stores the broadcasting stream from the head end server in the storage apparatus, and transmits the broadcasting stream pause completion message to the convergence service control unit.

Upon receiving the broadcasting stream pause completion message, the convergence service control unit changes the state of the broadcasting session in the internal storage space to a pause state and transmits a VoIP telephone service session set request message to the call session control unit. Accordingly, the call session control unit sets the VoIP telephone service session and transmits the VoIP telephone service session to the convergence service control unit. Next, the convergence service control unit stores the VoIP telephone service session, from among the sessions for providing the T-communication convergence service of the user 1 in the internal storage space, and changes the state of the VoIP telephone service session to a busy state.

Accordingly, the VoIP telephone service session set completion message is transmitted to the call session control unit. Then, the call session control unit provides the VoIP telephone service to the user terminal of the user 1. When the user 1 hangs up the VoIP telephone, the call session control unit transmits the VoIP telephone service disconnection message to the convergence service control unit. Next, the convergence service control unit changes the state of the VoIP telephone service session in the internal storage space to an unused state, changes the state of the broadcasting session to a busy state, and then transmits the broadcasting stream reproduction request message to the broadcasting service control unit. Upon receiving the broadcasting stream reproduction request message, the broadcasting service control unit reproduces the corresponding broadcasting stream, which was paused, from the storage apparatus, and transmits the broadcasting stream to the content convert unit. Next, the content convert unit transcodes the broadcasting stream so as to be suitable for the terminal codec so that the broadcasting stream can be viewed in the user terminal of the user 1, and transmits the broadcasting stream to the user terminal.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

The present invention relates to a method and apparatus for controlling a T-communication convergence service in a wired-wireless convergence network, wherein the T-communication convergence service, which is a type of communication-broadcasting convergence service, is controlled in the wired-wireless convergence network. Accordingly, the T-communication convergence service can be provided to a user through a wired or wireless terminal, such as a TV, a PDA, or a mobile phone, and to an enterpriser as a profit model for a communication-broadcasting convergence service. Also, by providing the function of controlling the T-communication convergence service, new various convergence services can be created. Also, by using a system for controlling convergence service that can be easily applied to a wired network, wireless network, and wired-wireless convergence network, without depending on a certain communication network, the function of controlling the T-communication convergence service can be used to the utmost while developing a function for controlling a new wired/wireless and communication-broadcasting convergence service. Accordingly, reusability of the function of controlling the T-communication convergence service can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for controlling a T-communication convergence service in a wired-wireless convergence network, the apparatus comprising:
a telecommunication service controller which sets a session for providing at least one of a telephone service and a communication service using an IP multimedia subsystem (IMS) based call session control unit in a wired-wireless convergence network;
a broadcasting service controller which sets a session for providing a broadcasting service based on a broadcasting service control unit in the wired-wireless convergence network; and
a convergence service provider which controls the set session by using an interface with the telecommunication service controller and the broadcasting service controller, manages states of the sessions, and provides at least one of the telephone service, the communication service, and the broadcasting service to a wired-wireless user terminal according to preset policy, about service providing and conversion between provided services, related to a communication-broadcasting convergence service.

2. The apparatus of claim 1, further comprising a service broker unit unit which controls application servers required for providing the communication-broadcasting convergence service based on the preset policy related to the communication-broadcasting convergence service.

3. The apparatus of claim 1, further comprising:
an integration profile storage unit which contains at least one of user information, information about a usable communication-broadcasting convergence service list, and the preset policy information related to the communication-broadcasting convergence service; and
a convergence service manager which provides the preset policy stored in the integration profile storage unit to the convergence service provider and authenticates a user who requested to communication-broadcasting convergence service.

4. The apparatus of claim 3, wherein the telecommunication service controller performs a network connection control function and a resource control function for wired-wireless convergence control, and when the user terminal is connected to a network, determines whether the user terminal is a usable terminal based on the information of the integration profile storage unit.

5. The apparatus of claim 1, further comprising:
a service directory which contains information about a service list that can be provided to a user; and
a user interface unit which provides a service list that can be selected by a certain user from the service directory, and based on a type of service selected by the certain user, transmits a service process request to the convergence service provider when the communication-broadcasting convergence service is selected, to the telecommunication service controller when the telephone service or the communications service is selected, and to the broadcasting service controller when the broadcasting service is selected.

6. The apparatus of claim 1, wherein the convergence service provider provides content of the communication-broadcasting convergence service to the user terminal after transcoding the content based on characteristics of the user terminal and connected network.

7. The apparatus of claim 1, wherein the broadcasting service controller performs a streaming control function required for providing the broadcasting service.

8. The apparatus of claim 1, wherein the telephone service is a voice over internet protocol (VoIP) service and the communication service is an instant messaging service.

9. The apparatus of claim 1, wherein the wired-wireless convergence network is a broadband convergence network.

10. A method of controlling an initialization of providing a T-communication convergence service in a wired-wireless convergence network, the method comprising:
when a communication-broadcasting convergence service request is received from a user terminal of the wired-wireless convergence network, determining whether a user is a rightful user of the communication-broadcasting convergence service by referring to an integration profile, in which user information and a preset policy related to the communication-broadcasting convergence service, is contained;
when the user is determined to be a rightful user, determining a service to be provided initially by checking the preset policy related to the communication-broadcasting convergence service of the user from the integration profile;
when the determined service is a broadcasting service, setting a session for providing the broadcasting service using a broadcasting service control unit;
when the determined service is a telephone service or a communication service, setting a session for providing the telephone service or the communication service using an IMS based call session set function;
storing the set session for providing the broadcasting service, telephone service, or communication service in an internal space for the user and changing states of the set session to busy states; and
providing content of the service to a user terminal after converting the content based on characteristics of the user terminal and a connected network through the set session.

11. The method of claim 10, before determining whether the user is the rightful user, the method further comprising:
when a user terminal connected to the wired-wireless convergence network is found, determining whether the connected user terminal is a usable terminal using an IMS based call session control function; and
when the connected user terminal is determined to be the usable terminal, providing a service list that can be provided through a user interface to the connected user terminal.

12. A method of controlling conversion of a T-communication convergence service in a wired-wireless convergence network, the method comprising:
when a message reception request, which is communication service, is received by a user terminal while providing a broadcasting service to the user terminal based on a preset policy related to a communication-broadcasting convergence service, confirming that the user terminal is provided with the communication-broadcasting convergence service from an integration profile, in which user information and communication-broadcasting convergence service utilization state information of a user are stored;
setting a communication message session for receiving a requested message by using an IMS based call session control function;
storing the set communication message session in an internal space and changing state of the set communication message session to a busy state; and
providing the requested message to the user terminal through the set communication message session by using the call session control function.

13. The method of claim 12, wherein the requested message is an internet based instant message.

14. A method of controlling conversion of a T-communication convergence service in a wired-wireless convergence network, the method comprising:
when a request for providing a VoIP service is received by a user terminal while providing a broadcasting service to the user terminal based on a preset policy related to a communication-broadcasting convergence service, confirming that the user terminal is provided with the communication-broadcasting convergence service from an integration profile, in which user information and communication-broadcasting convergence service utilization state information of a user are stored;
pausing transmitting of a broadcasting service stream to the user terminal by recognizing that the broadcasting service is being provided from among the communication-broadcasting convergence service;
storing the broadcasting service stream, which is transmitted from a server, for a pausing period, and changing a state of a session for the broadcasting service to a pause state;
setting a session for the requested VoIP service using an IMS based call session control function;
storing the set session for the requested VoIP service and changing a state of the set session for the requested VoIP service to a busy state; and
connecting the requested VoIP service to the user terminal through the set session for the requested VoIP service by using the call session control function.

15. The method of claim 14, after connecting the requested VoIP service to the user terminal, the method further comprising:
changing the state of the session for the requested VoIP service stored in the internal space to an unused state when the VoIP service communication is completed; and
changing the state of the session for the broadcasting service, which is paused, to a busy state, transmitting the stored broadcasting service stream for the pausing period, to the user terminal, and reproducing the broadcasting service stream.
